(19) United States
(12) Patent Application Publication
(10) Pub. No.: US 2004/0133392 A1
(43) Pub. Date: Jul. 8, 2004

(54) Process for the assisted comparison of objects decsribed by a set of characteristics

(76) Inventors: Giovanni Sacco, Torino (IT); Maria Teresa Grassi Mantelli, Torino (IT)

Correspondence Address: Oblon Spivak McClelland, Maier & Neustadt, Fourth Floor, 1755 Jefferson Davis Highway, Arlington, VA, 22202, US

(21) Appl. No.: 10/479,179

(22) PCT Filed: May 14, 2002
(86) PCT No.: PCT/IT02/00315

(30) Foreign Application Priority Data
May 30, 2001 (IT) TO01A000513

(51) Int. Cl. G06F 17/18

(52) U.S. Cl. 702/179

(57) ABSTRACT

The present invention refers to an assisted comparison process for objects described by a set of characteristics.

The comparison of a set of objects described by some characteristics frequently occurs in many applications. As an example, let us consider the selection of a car to be purchased. There might be several available models, each of which is generally described by a high number of characteristics (price, horsepower, etc.). In order to select the model which best fits his requirements, the user has to compare the characteristics of all the models: if there are N models, each described by M characteristics, the comparisons to be performed are M×N.

Although there are ways to reduce the number of objects to be compared (“start game”: e.g. database queries), the final comparison (“end game”) on the selected objects must be performed anyway and even the simple comparison of 10 objects with 20 characteristics requires 200 comparisons.

Object of the present invention is solving these prior-art problems, by providing a process that simplifies the comparison through an innovative use of color coding, ordering and selectable presence of objects and characteristics, in order to minimize the effort required in the selection.

The above and other objects and advantages of the invention, as will appear from the following description, are obtained by a process as claimed in claim 1. Preferred embodiments and non-trivial variations of the present invention are claimed in the dependent claims.

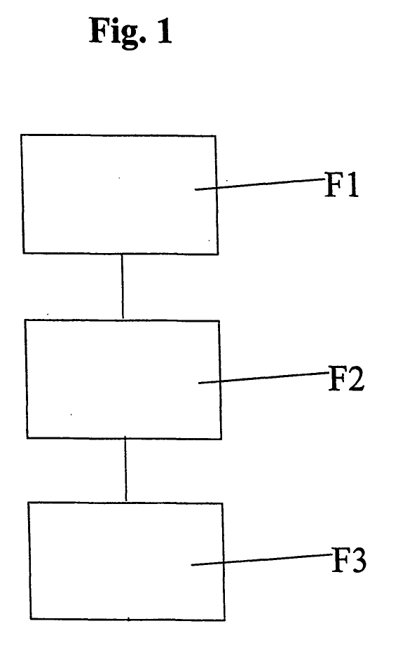

The present invention will be better described by some preferred embodiments thereof, given as a non-limiting example, with reference to the enclosed drawings, in which FIG. 1 is a schematic block diagram of the main steps of the process according to the present invention.

In order to simplify the following description and with no loss of generality, it will be assumed that data are presented as a table with a column for each object and a row for each characteristic; a cell in said table is denoted by T(R, C), where R identifies the row and C the column.

It is explicitly assumed that for each value of each characteristic in the table there exists a merit weight which measures the “desirableness” of a specific value with respect to the other values of the same characteristic in the table. Said weight is previously defined, or supplied by the user or computed from arbitrary parameters (among which, with no loss of generality, a set of values of the specific characteristic). In the trivial case, the merit weight is the same for all the possible values of a specific characteristic. As an example, the merit weight for the Price characteristic is usually decreasing, that is a higher price is less desirable than a lower price.

It is further explicitly assumed that for each object in the table there exists a global merit weight that measures the “desirableness” of said object that has said values in its characteristics. Said global merit weight is previously defined, or supplied by the user or computed from arbitrary parameters (among which, with no loss of generality, a set of objects). In the trivial case, the global weight is the same for all the objects. As an example, with no loss of generality, a relative weight can be assigned to each characteristic (which weighs the importance of each characteristic) and the global weight can be computed as the weighted sum of the merit weight for each characteristic value.

Under such assumptions, referring to FIG. 1, the process of the current invention is used for the assisted selection of objects described by a set of characteristics, comprising the steps of:

showing (F1) to the user all the values of all characteristics of the objects;

for each value shown to the user of each characteristic shown to the user, providing (F2) a merit weight which measures the “desirableness” of said value with respect to the other values of the same characteristic shown to the user; and

for each object shown to the user, providing (F3) a global merit weight that measures the “desirableness” of said object with respect to the other objects shown to the user.

The process simplifies the comparison in the following way:

1. Each row in the table with the same value in each cell is represented by a color-coding that identifies the fact that all the values are equal (e.g., grey). Such rows can be discarded and restored by the user through appropriate commands. A clear indication of equal characteristics (and their possible elimination) is especially important when the “start game” is used. In this case, many characteristics will be equal, but not easily perceived as such by the user;

2. for each cell in the table, a color-coding is used such as to identify the desirableness (merit) of that cell with respect to the other cells of the same characteristic, a “neutral” color coding can be used for the characteristic value which corresponds to the average or the median of the characteristics values in the table, or to the maximum frequency of such values (and therefore, by definition, for all the values of characteristics with merit weights equal for each value) or to an arbitrary value. For instance, for the Price characteristic, one can use a white background for the average or median price, a background with a redder shade for increasing prices larger than the average or median value, and a background with a greener shade for decreasing prices lower than the average or median;

3. appropriate commands allow ordering the columns in the table according to the global merit value of each column (object);

4. appropriate commands allow the user to selectively discard from the table one or more rows (uninteresting characteristics). Discarded rows can be subsequently restored. Row discarding and restoring requires, in general, the recomputation of global merit weights and consequently the ordering specified at item 3;

5. appropriate commands allow the user to selectively discard from the table one or more columns (uninteresting objects). Discarded columns can be recovered. Column discarding and restoring requires, in general, the recomputation of equal characteristics (item 1) for the remaining objects, and the recomputation of merit weights and color coding for each cell (item 2);

6. appropriate commands allow the user to discard from the table the columns for objects that do not satisfy a boolean expression on the values of some characteristics. In the simplest case and with no loss of generality, a command applied to a cell with a value T(R, C), discards from the table all the columns C′ for the objects that have a value T(R, C′) different from T(R, C). As an example, if the user applies the command to the cell T(Brand, C)=“Audi”, all the models with a Brand different from “Audi” will be discarded. Column discarding and restoring requires the operations specified in item 5. As an additional example, a command applied to a characteristic can show all the unique values that such characteristic has for the objects displayed to the user, and allow the user to deselect one or more of these values and consequently discard all those objects that have said values.

Some implementations of the invention were described but, obviously, they are open to additional variations within the same inventive idea. For instance, the objects displayed to the user could be contained into multidimensional sets instead of bidimensional tables.

1. Process for an assisted selection of objects described by a set of characteristics, characterized in that it comprises the steps of:
showing (F1) to a user all the values of all characteristics of suitably organised objects;
for each value shown to the user of each characteristic shown to the user, providing (F2) a merit weight which measures the “desirableness” of said value with respect to the other values of the same characteristic shown to the user; and
for each object shown to the user, providing (F3) a global merit weight that measures the “desirableness” of said object with respect to the other objects shown to the user.

2. Process according to claim 1, characterized in that for the characteristics with equal values for all the objects displayed to the user, said values are represented by a color coding which indicates the equality of said values.

3. Process according to claim 2, characterized in that appropriate commands allow discarding and restoring the characteristics with the same value for all the objects.

4. Process according to claim 2, characterized in that a color coding is used to identify the desirableness (merit) of each value shown to the user, with the possible exception of the characteristics with equal values for all the objects.

5. Process according to claim 4, characterized in that for each characteristic a neutral color coding is used for those values which correspond to the average or median of the values or to the maximum frequency of said values or to an arbitrary value.

6. Process according to claim 1, characterized in that appropriate commands allow ordering the objects displayed to the user according to their global merit weight.

7. Process according to claim 1, characterized in that appropriate commands allow selectively discarding and restoring one or more objects, said discarding/restoring requiring, in general, the recomputation of merit weights.

8. Process according to claim 1, characterized in that appropriate commands allow selectively discarding and restoring one or more characteristics, said discarding/restoring requiring, in general, the recomputation of global merit weights.

9. Process according to claim 7, characterized in that appropriate commands allow discarding the columns for objects that do not satisfy a boolean expression on the values of some characteristics.

10. Process according to claim 9, characterized in that appropriate commands applied to a value V of a characteristic C of an object discard all the objects that have or do not have said value V for characteristic C.

11. Process according to claim 9, characterized in that appropriate commands applied to a characteristic C allow showing all unique values that said characteristic C has for the objects displayed to the user, and allow the user to deselect one or more values, consequently discarding all those objects that have said values for characteristic C.
